(19) United States
(12) Patent Application Publication
(10) Pub. No.: US 2014/0250763 A1
(43) Pub. Date: Sep. 11, 2014

(54) Articulated Fishing Lure

(71) Applicant: Richard E. Hrncir, Palmer, TX (US)

(72) Inventor: Richard E. Hrncir, Palmer, TX (US)

(21) Appl. No.: 14/198,619

(22) Filed: Mar. 6, 2014

Related U.S. Application Data
(60) Provisional application No. 61/775,225, filed on Mar. 8, 2013.

(51) Int. Cl. A01K 85/18; A01K 85/01; A01K 85/14

(52) U.S. Cl. CPC A01K 85/18; A01K 85/14; A01K 85/01
USPC 43/42.06; 43/42.15

(57) ABSTRACT

A fishing lure includes a lure body having a head portion and a tail portion. The head portion is movably coupled to the tail portion such that the head portion may move relative to the tail portion when the lure is pulled through the water.

### CROSS-REFERENCE TO RELATED APPLICATIONS

Priority is claimed from U.S. Provisional Application No. 61/775,225 filed on Mar. 8, 2013.

### STATEMENT REGARDING FEDERALLY SPONSORED RESEARCH OR DEVELOPMENT

Not applicable.

### BACKGROUND

This disclosure relates generally to the field of to fishing lures. More particularly, this disclosure relates to a fishing lure that includes an articulated lure body comprising a head portion and a tail portion. The head portion is movably coupled to the tail portion so that head and tail portions may move relative to each other. The lure body may be made of a variety of materials known in the art, including rigid or semi-rigid materials such as balsa wood and plastic. The lure body also includes hooks and other features, including an attachment for, i.e., a fishing line, a swivel, or other means of coupling a fishing line to the fishing lure. The head portion may also include a fully rotatable shank having spinners, beads, swivels, hooks, or other features. Other embodiments may include a solid bodied lure comprising one or more rattles disposed proximate a head portion of the lure. The solid bodied embodiment may likewise include any of the additional attributes disclosed above, including a head portion having a fully rotatable shank having spinners, beads, swivels, hooks, or other features.

Slabs and jigs are well known types of fishing lures and are used to attract a variety of fish species. Slabs typically include one or more hooks attached to a slab body, which may be formed from a number of materials, including lead. Jigs typically have hooks partially embedded within a jig body, which may be formed from lead or another relatively dense material. Slabs known in the art generally have one or more hooks attached to the slab body, wherein the slab body is designed to mimic the size, coloring, and shape of a bait fish. Jigs known in the art generally include spinners or propellers to add desirable fish-attracting effects. The spinners or propellers are generally attached to a shank that is fixed relative to the slab body.

A representative example fishing lure known in the art is described in U.S. Pat. No. 7,743,549 issued to Troutman. Relevant features of the lure described in the foregoing patent include a hook having a bend adjacent a barb to define a rear end of the lure and a shank extending toward an opposite front end of the lure. A lure body is attached to a portion of the shank of the hook and a movable support member extends from the lure body toward the front end of the lure and generally away from the rear end of the lure. A movable member, such as a spinner blade or a propeller, is movably associated with the movable support member for moving during use of the lure to attract fish to the lure. The movable member is located forward of the lure body adjacent the front end of the lure. A line attachment member is located adjacent the body for securement of a fishing line to the lure. The line attachment member is located between the rear end of the lure and the movable member. In a preferred embodiment, the line attachment member is provided by an eye of the hook that extends from the lure body.

Another type of lure known in the art is a hard bait lure, which may also be referred to as a crank bait or a twitch bait. These lures are typically formed from rigid materials that are buoyant in water. The lures may include attachments for a fishing line and for one or more hooks, such as treble hooks. These hard bait lures may further be painted to mimic fishing bait. For example, one such prior art hard bait lure has a unitary body. The body includes an attachment for a fishing line at the rear of the body. One or more treble hooks may be positioned at the front and rear of the lure body. The lure body may be painted to resemble a typical bait, such as a grasshopper or a cricket. When pulled through the water by the attached fishing line, the unitary bait is designed to mimic the natural behavior of the bait.

### SUMMARY

A fishing lure according to one aspect includes a lure body having a head portion and a tail portion. The head portion is movably coupled to the tail portion such that the head portion may move relative to the tail portion when the lure is pulled through the water.

In one embodiment the lure includes a lure body having a head portion and a tail portion. The head portion is movably connected to the tail portion so that the head portion is capable of moving relative to the tail portion. The movement of the head portion relative to the tail portion forms an articulated lure that mimics the behavior of certain types of bait species. In one embodiment the head portion may move laterally (i.e., in a horizontal plane) relative to the tail portion so that when the lure is attached to and pulled by a fishing line the lure appears to be a crayfish darting or scuttling rearwards. This movement pattern accurately reproduces the movement of a crayfish in nature. Another embodiment includes a lure body having a head portion and a tail portion. The movement of the head portion relative to the tail portion forms a lure that mimics the behavior of certain types of bait species. In one embodiment the head portion may move laterally (i.e., in a horizontal plane) relative to the tail portion so that when the lure is attached to and pulled by a fishing line the lure appears to be a crayfish darting or scuttling rearwards. This movement pattern accurately reproduces the movement of a crayfish in nature.

Other aspects and advantages will be apparent from the following description and the appended claims.

### BRIEF DESCRIPTION OF THE DRAWINGS

FIG. 1 shows an example articulated lure according to an embodiment according to the present disclosure.

FIG. 2 shows an example articulated lure having a rotatable shank according to an embodiment according to the present disclosure.

FIG. 3 shows an example of a solid bodied lure according to another embodiment of the disclosure.

### DETAILED DESCRIPTION

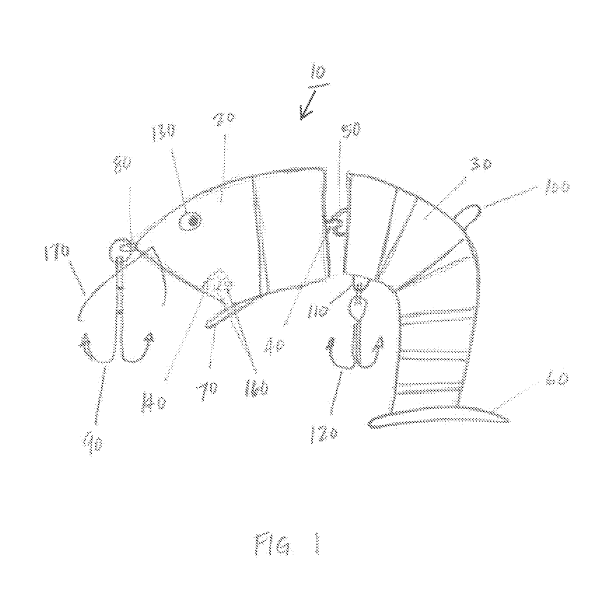

FIG. 1 shows an example of a lure in accordance with one embodiment. The lure 10 includes a body having a head portion 20 and a tail portion 30. The head portion 20 may include a first attachment 40 that may be coupled to a second attachment 50 included in the tail portion 30. The connection between the head portion 20 and the tail portion 30 may form an articulated lure in which the head portion 20 may move relative to and independent of the tail portion 30.

The lure body, including the head portion 20 and the tail portion 30, may be formed from any suitable material known in the art. In one embodiment, the lure 10 may be formed from balsa wood. In another embodiment, the head portion 20 and the tail portion 30 may be carved from a single block of balsa wood and may be separated at a parting line adjacent to the locations on which the attachments 40, 50 are located. In another embodiment, the lure 10 may be formed from plastic having a suitable density for use in fishing lures. In yet another embodiment, the lure 10 may be formed from any material known in the art that has a density approximately that of balsa wood or which is suitable for use in fishing lures, including crank and twitch baits.

The head portion 20 may include a hook attachment 80 that may also include a split ring, a swivel, or other attachment features known in the art. A hook 90, such as a treble hook, may be coupled to the hook attachment 80. The head portion 20 may also include ornamentation such as an eye 130, antennae, whiskers, or feelers 170, and other devices intended to simulate a bait species. The example implementation shown in FIG. 1 is intended to mimic a crayfish.

The head portion 20 may also include a device such as a bill 70. The bill 70 helps ensure that the movement of the head portion 20 is consistent. The bill 70 may also help ensure that movement of the head portion 20 is in a lateral plane that is roughly horizontal to the tail portion 30. This distinctive “wobble” is characteristic of a crayfish as is moves in the water and is one of the possible advantages of a lure according to the present disclosure. The bill 70 may be made from metal, plastic, or any other suitable material and may be shaped to produce a desired movement of the lure 10.

In one embodiment, the head portion 20 may further include a hollow cavity 140 positioned on a lower surface. This cavity 140 may be filled with weights 160 of different sizes (often referred to as “shot” or “split shot”). In some embodiments, the total weight may be adjusted so that the head portion 20 of the lure 10 is substantially neutrally buoyant. In other embodiments, different weights 160 may be selected for use with the lure 10 such that the lure 10 assumes other positions when submerged. Alternatively, the hollow cavity 140 may include both weights 160 and one or more “rattlers” (not shown) designed to create a distinctive rattling sound when the head portion 20 moves relative to the tail portion 30. In some embodiments, the rattlers (not shown) may be formed using two or more brass beads (not shown) positioned in the hollow cavity 140 and permitted to contact one another when the lure 10 is pulled through the water.

In yet another embodiment the hollow cavity 140 may be filled with a sufficient quantity of “rattlers” such that few if any weights 160 are required to achieve neutral buoyancy. Once the weights 160 or rattlers (not shown) are placed in the cavity 140, the cavity 140 may be filled with glue, epoxy, or another material known in the art, or may be covered with a seal of a type known in the art in order to seal the cavity 140 and make the cavity 140 water-tight.

The tail portion 30 of the lure 10 may be shaped to resemble the body of a bait species, such as a crayfish. The tail portion 30 may include an attachment 100 to which a fishing line (not shown) may be connected. In some embodiments, a fishing line may be connected to the attachment 100 using a split ring, a swivel, or any other attachment mechanism or device known in the art. In other embodiments a fishing line may be directly connected to the attachment 100.

In one embodiment, the attachment 100 may be positioned along the tail portion 30 in such a way that the lure 10 will remain in approximately the position shown in FIG. 1 when the lure 10 is pulled through the water. Specifically, the head portion 20 may include weights 160 in the hollow cavity 140 such that the head portion 20 remains roughly in the position shown in FIG. 1 when the lure is submerged. When the lure 10 is positioned as shown in FIG. 1 and is pulled through the water, the head portion 20 is designed to move back and forth (i.e., in and out of the paper) such that the movement of the lure 10 mimics the behavior of a crayfish when it darts or scuttles along the bottom of a body of water. This naturally appearing movement of the lure 10 may be appealing to many fish species.

The tail portion 30 may also include a lip 60. The lip 60 may serve one or more functions, depending on the embodiment. In one example embodiment, the lip 60 may serve as a brake that slows the descent of the lure 10 when it is placed in the water. In another example embodiment, the lip 60 may serve as a “plane” or “diving plane” that helps keep the lure 10 close to the bottom of the body of water in which the lure 10 is submerged. In another example embodiment, the lip 60 may be designed to control the manner in which the lure 10 is positioned as it is pulled through the water. For example, if a fishing line is attached to attachment 100 and the lure 10 is pulled in a rearward direction, the lip 60 will act to pull the tail portion 30 downward with respect to the head portion 20 and thereby maintain the shape of the lure 10 in a substantially natural position, as shown in FIG. 1. Further, some embodiments of the invention may use the lip 60 for more than one of the foregoing design considerations. In some embodiments, the tail portion 30 may also include a weight (not shown) made from a high density material such as lead near the base of the lip 60. This weight may help maintain a selected position of the tail portion 30 with respect to the head portion 20 when the lure 10 is submerged. In one embodiment, the weight may be about 0.2 ounces.

In one embodiment, the lip 60 may be sized to enable the lure 10 to sink at a controlled rate. For example, in one embodiment the lip 60 may be sized and/or shaped such that the lure 10 will descend at a rate of approximately 0.5 to 1.0 feet per second. However, the scope of the present disclosure is not limited to these example rates of descent, and other rates may be selected by appropriately sizing and shaping the lip 60 and selecting other properties of the lure 10, such as the overall weight of the lure 10. In other embodiments, the lip 60 may be sized and positioned such that it helps prevent the lure 10 from being caught on submerged debris.

Furthermore, the location of the attachment 100 may be selected to enable other positions of the head portion 20 and tail portion 30 when the lure 10 is submerged and is pulled through the water. In one embodiment, a distance between the bottom-most edge of the attachment 100 and the lip 60 may be approximately 0.875 inches.

The tail portion 30 may also include an attachment 110. The attachment 110 may be configured to connect to a second hook 120, such as a treble hook. In some embodiments, the attachment 110 may further include a split ring or other device the connects the attachment 110 to the second hook 120. In other embodiments, the second hook 120 may be a short shank treble hook selected such that the second hook 120 will not interfere with the movement of the tail portion 30 and, specifically, such that the second hook 120 will not interfere with the movement, position, or attitude of the lip 60.

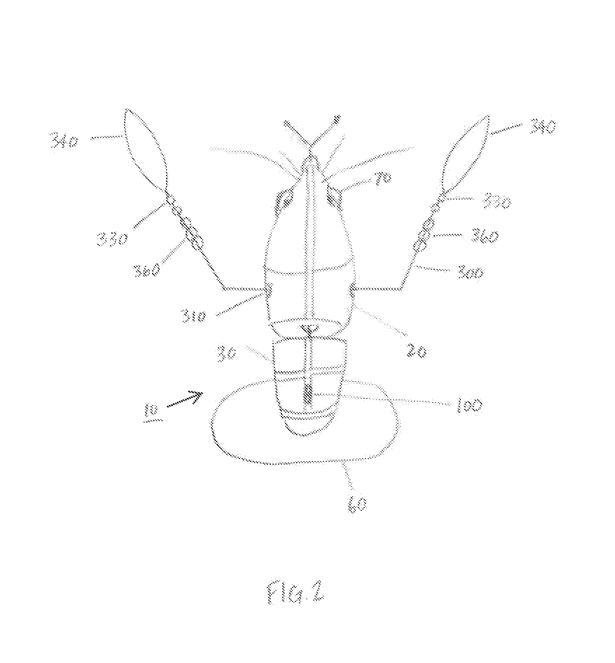

In another example embodiment, shown in FIG. 2, the lure 10 may also include a shank 300. In one embodiment, shown in FIG. 2, the shank 300 may have one or more bends proximate its midpoint, where the shank 300 passes through a suitably located opening 310 in the head portion 20. In some embodiments, the shank 300 is capable of rotating through a full 360 degrees relative to the head portion 20 so as to mimic the behavior of various bait species. For example, in some embodiments the shank 300 mimics the claws of crayfish as a crayfish moves through the water.

The shank 300 may also include swivels 330, which are coupled to blades 340, spinners, or other devices designed to attract fish. The swivels 330 enable the blades 340 to rotate 360 degrees with respect to the shank 300. The shank 300 may further include additional attachments, including beads 360, a skirt (not shown), or other structures known in the art designed to mimic bait species or to attract fish to the lure 10.

Further, the lure 10 may include a coating of types known to attract fish. For example, the coating may comprise an epoxy suitable for underwater use. Moreover, the coating may include metallic flecks or glitter (neither shown separately) in various colors. Further, the coating may also comprise a scent or other visual attractant designed to enhance the appeal of the lure 10 to fish.

In the various examples shown in and explained above with reference to FIG. 2, a shank passing through the lure body is configured to be able to freely rotate (i.e. through a full 360 degrees) with respect to the lure body. Such full rotation is believed to make a lure according to the invention more effective at attracting fish than lures not including such fully rotational shank.

Various aspects of the lure 10 described above with reference to FIGS. 1 and 2 may be used individually or in combination. For example, the lure 10 may be silent or rattle if “rattlers” are included in the hollow cavity in the head portion. Further, the lure may include a rotatable shank as shown in FIG. 2 or may be otherwise formed in accordance with the embodiment shown in FIG. 2. Other embodiments may include both “rattlers” and a rotatable shank. Other embodiments may include rotatable shanks that are restricted to rotate through less than a full 360 degrees.

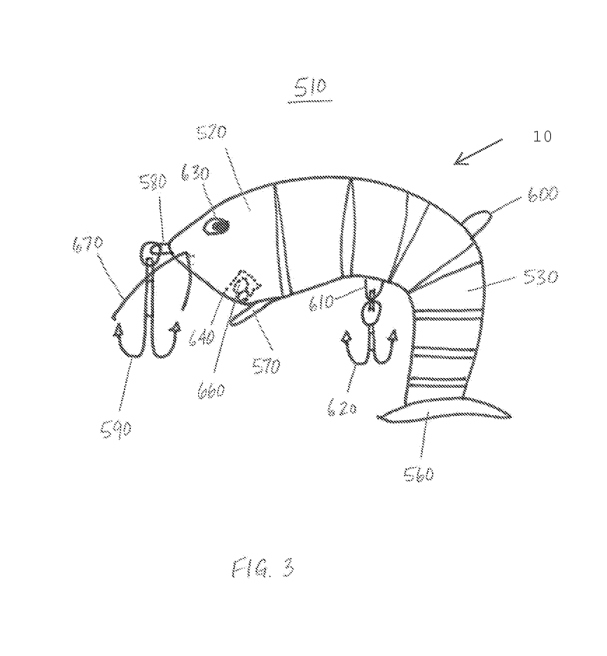

In another example embodiment, shown in FIG. 3, the lure 510 may be a solid bodied lure. The lure 500 includes a body having a head portion 520 and a tail portion 530. The lure body, including the head portion 520 and the tail portion 530, may be formed from any suitable material known in the art. In one embodiment, the lure 510 may be formed from balsa wood. In another embodiment, the lure 510 may be formed from plastic having a suitable density for use in fishing lures. In yet another embodiment, the lure 510 may be formed from any material known in the art that has a density approximately that of balsa wood or which is suitable for use in fishing lures, including crank and twitch baits.

The head portion 520 includes a hook attachment 580 that may also include a split ring, a swivel, or other attachment features known in the art. A hook 590, such as a treble hook, may be coupled to the hook attachment 580. The head portion 520 may also include ornamentation such as an eye 630, antennae, whiskers, or feelers 670, and other devices intended to simulate a bait species. The example implementation shown in FIG. 3 is intended to mimic a crayfish.

The head portion 520 may also include a device such as a bill 570. As in other embodiments, the bill 570 helps ensure that the movement of the head portion 520 is consistent. The bill 570 may also help ensure that movement of the head portion 520 is in a lateral plane that is roughly horizontal to the tail portion 530. This distinctive “wobble” is characteristic of a crayfish as is moves in the water and is one of the advantages of the present invention. The bill 570 may be made from metal, plastic, or any other suitable material and may be shaped to produce a desired movement of the lure 510.

In one embodiment, the head portion 520 may further include one or more hollow cavities 640 positioned on a lower surface. The one or more cavities 640 may be filled with weights 660 of different sizes (often referred to as “shot” or “split shot”). In some embodiments, the total weight may be adjusted so that the lure 510 is substantially neutrally buoyant. In other embodiments, different weights 660 may be selected for use with the lure 510 such that the lure 510 assumes other positions when submerged. Alternatively, the one or more hollow cavities 640 may include both weights 660 and one or more “rattlers” (not shown) designed to create a distinctive rattling sound when the lure 510 moves through the water. In some embodiments, the rattlers (not shown) may be formed using two or more brass beads (not shown) positioned in the one or more hollow cavities 640 and permitted to contact one another when the lure 510 is pulled through the water. In other embodiments, the walls of the one or more hollow cavities 640 may be lined with metal or another material that enhances the rattling sound produced by the rattlers.

In yet another embodiment the one or more hollow cavities 640 may be filled with a sufficient quantity of “rattlers” such that few if any weights 660 are required to achieve neutral buoyancy. Once the weights 660 or rattlers (not shown) are placed in the one or more cavities 640, the cavities 640 may be filled with glue, epoxy, or another material known in the art, or may be covered with a seal of a type known in the art in order to seal the cavities 640 and make the cavities 640 water-tight.

The tail portion 530 of the lure 510 may be shaped to resemble the body of a bait species, such as a crayfish. The tail portion 530 may include an attachment 600 to which a fishing line (not shown) may be connected. In some embodiments, a fishing line may be connected to the attachment 600 using a split ring, a swivel, or any other attachment mechanism or device known in the art. In other embodiments a fishing line may be directly connected to the attachment 600.

In one embodiment, the attachment 600 may be positioned along the tail portion 530 in such a way that the lure 10 will remain in approximately the position shown in FIG. 3 when the lure 510 is pulled through the water. Specifically, the head portion 520 may include weights 660 in the one ore more hollow cavities 640 such that the head portion 520 remains roughly in the position shown in FIG. 3 when the lure is submerged. When the lure 510 is positioned as shown in FIG. 3 and is pulled through the water, the head portion 520 is designed to move back and forth (i.e., in and out of the paper) such that the movement of the lure 510 mimics the behavior of a crayfish when it darts or scuttles along the bottom of a body of water. This naturally appearing movement of the lure 510 may be appealing to many fish species.

The tail portion 530 may also include a lip 560. The lip 560 may serve one or more functions, depending on the embodiment. In one example embodiment, the lip 560 may serve as a brake that slows the descent of the lure 510 when it is placed in the water. In another example embodiment, the lip 560 may serve as a “plane” or “diving plane” that helps keep the lure 510 close to the bottom of the body of water in which the lure 510 is submerged. In another example embodiment, the lip 560 may be designed to control the manner in which the lure 510 is positioned as it is pulled through the water. For example, if a fishing line is attached to attachment 600 and the lure 510 is pulled in a rearward direction, the lip 560 will act to pull the tail portion 530 downward thereby maintain the shape of the lure 510 in a substantially natural position, as shown in FIG. 3. Further, some embodiments of the invention may use the lip 560 for more than one of the foregoing design considerations. In some embodiments, the tail portion 530 may also include a weight (not shown) made from a high density material such as lead near the base of the lip 560. This weight may help maintain a selected position of the tail portion 530 with respect to the head portion 520 when the lure 510 is submerged. In one embodiment, the weight may be about 0.2 ounces.

In one embodiment, the lip 560 may be sized to enable the lure to sink at a controlled rate. For example, in one embodiment the lip 560 may be sized and/or shaped such that the lure 510 will descend at a rate of approximately 0.5 to 1.0 feet per second. However, the scope of the present disclosure is not limited to these example rates of descent, and other rates may be selected by appropriately sizing and shaping the lip 560 and selecting other properties of the lure 510, such as the overall weight of the lure 510. In other embodiments, the lip 560 may be sized and positioned such that it helps prevent the lure 510 from being caught on submerged debris.

Furthermore, the location of the attachment 600 may be selected to enable other positions of the lure 510 when the lure 510 is submerged and is pulled through the water. In one embodiment, a distance between the bottom-most edge of the attachment 600 and the lip 560 may be approximately 0.875 inches.

The lure 510 also include additional attachments, such as attachment 610. The attachment 610 may be configured to connect to a second hook 620, such as a treble hook. In some embodiments, the attachment 610 may further include a split ring or other device the connects the attachment 610 to the second hook 620. In other embodiments, the second hook 620 may be a short shank treble hook selected such that the second hook 620 will not interfere with the movement of the lure 510 and, specifically, such that the second hook 620 will not interfere with the movement, position, or attitude of the lip 560.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A fishing lure, comprising:
a lure body having a head portion and a tail portion;
a coupling for movably connecting the head portion to the tail portion such that the head portion is capable of moving relative to the tail portion when the lure is pulled through the water.

2. The lure of claim 1 wherein the head portion comprises a bill adapted to wobble the head portion from side to side when the lure is pulled through the water.

3. The lure of claim 1 wherein the tail portion comprises a lip adapted to control the descent of the lure when the lure is placed in the water.

4. The lure of claim 1 wherein the lure further comprises a shank coupled to the head portion through an opening in the head portion, the opening having a size and the shank configured to enable the shank to freely rotate within the opening.

5. The lure of claim 4 wherein the shank comprises a bend disposed proximate a longitudinal center thereof.

6. The lure of claim 4 wherein the shank comprises at least one swivel thereon.

7. The lure of claim 6 wherein the swivel includes at least one of a blade or a spinner coupled thereto.

8. The lure of claim 1 further comprising a coating on the head portion and the tail portion.

9. The lure of claim 8 wherein the coating comprises epoxy.

10. The lure of claim 8 wherein the coating comprises a scent material.

11. The lure of claim 1 including at least one hook coupled to the head portion.

12. The lure of claim 1 wherein the head portion and tail portion comprise balsa wood.

13. A fishing lure, comprising:
a lure body having a head portion, the head portion comprising a bill adapted to wobble the head portion from side to side when the lure is pulled through the water; and
a tail portion, the tail portion comprising a lip adapted to control the position of the lure when the lure is placed in the water.

14. The lure of claim 13 wherein the lip is further adapted to control the descent of the lure when the lure is placed in the water.

15. The lure of claim 14 where in the lure descends at a rate of 0.5 to 1.0 feet per second when the lure is placed in the water.

16. A fishing lure comprising:
a lure body having a head portion, the head portion comprising a bill adapted to wobble the head portion from side to side when the lure is pulled through the water;
a tail portion, the tail portion comprising a lip adapted to control the position of the lure when the lure is placed in the water; and
one or more rattlers disposed in the head portion of the lure.
